(19) United States
(12) Patent Application Publication
(10) Pub. No.: US 2019/0291673 A1
(43) Pub. Date: Sep. 26, 2019

(54) MODULAR GRILL GUARD

(71) Applicant: Black Horse Off Road of GA Inc., Royston, GA (US)

(72) Inventors: Fadi Ajam, Forest Hills, NY (US); Matthew Kemme, Brooklyn, NY (US)

(73) Assignee: Black Horse Off Road of GA Inc., Royston, GA (US)

(21) Appl. No.: 16/405,430

(22) Filed: May 7, 2019

Related U.S. Application Data
(63) Continuation-in-part of application No. 16/359,499, filed on Mar. 20, 2019.
Application No. 16/359,499 is a continuation-in-part of application No. 16/356,732, filed on Mar. 18, 2019.
(60) Provisional application No. 62/646,161, filed on Mar. 21, 2018.

(51) Int. Cl. B60R 19/52; B60Q 1/18

(52) U.S. Cl. CPC B60R 19/52; B60Q 1/18

(57) ABSTRACT

A modular grill guard that is mounted in front of a vehicle includes a main guard having a right bar, a left bar and a first cross member connected to the right bar and the left bar. A right guard is removably connected to the right bar, the right, guard includes a right guard member and a right guard bracket, the right guard bracket providing the removable connection to the right bar and extends from the right guard bracket. A left guard is removably connected to the left bar, the left guard includes a left guard member and a left guard bracket, the left guard bracket providing the removable connection to the left bar, the left guard member extending from the left guard bracket. Connecting brackets extend from the right bar and left bar to connect the modular grill guard to the vehicle.

### REFERENCE TO RELATED APPLICATION

This application is a continuation-in-part of U.S. Nonprovisional patent application Ser. No. 16/359,499 filed on Mar. 20, 2019, which claims priority to U.S. Provisional Patent Application No. 62/646,161 filed on Mar. 21, 2018 and is a continuation-in-part of U.S. Nonprovisional patent application Ser. No. 16/356,732 filed on Mar. 18, 2019, the entire contents of these applications being incorporated herein by reference.

### BACKGROUND

Roll bars, like many other after-market vehicle accessories, have become very popular, especially among drivers of pick-up trucks and other vehicles (e.g. recreational vehicles, dune buggies, sport-utility vehicles, etc.) that are driven off-road. Roll bars provide support for the cab of the vehicle to which they are mounted, which is helpful in the event of a rollover or on other occasions. Roll bars also improve the appearance of the vehicles on which they are installed by, for instance, making the vehicles appear to be more capable of traversing difficult terrain than other vehicles. Additionally, roll bars provide a surface to which additional accessories may be mounted (e.g. lighting equipment, cargo racks, etc.). As a result of these benefits, roll bars have become very popular.

Traditional roll bars are often bulky, making them expensive to ship and difficult to install by a single person. These bulky designs are typically either permanently installed or are installed in such a way that it makes it difficult to install the roll bar and to remove the roll bar, or the components and/or accessories of the roll bar, from the vehicle on which the roll bar is installed. Further, the installation of traditional roll bars may require permanent modifications to the vehicle, including cutting out portions of the vehicle's body to access the area of the frame on which a traditional roll bar is mounted. This type of installation is more complicated than the average do-it-yourself vehicle owner would feel comfortable handling. What is needed is a roll bar that fits easily within a standard box for shipping by mail, that has modular components that are easily assembled and that is easily installed and/or removed by a single person, in whole or in part.

Other automotive parts also benefit from modular designs. For instance, grill guards are typically shipped as bulky, one piece designs that bolt directly to the frame, bumper, etc. of a vehicle. Because they are bulky, traditional grill guards can be difficult to install and require large, expensive packaging to ship. What is needed is a grill guard design that is easily assembled and installed by a single person and that easily fits within a standard shipping box for conventional shipment by mail.

### SUMMARY

According to one implementation described herein, a modular roll bar that is designed to be mounted on the bed rails of a pickup truck includes a first bracket designed to be installed on a driver's side bed rail of the pickup truck. The first bracket includes a first lower surface associated with the driver's side bed rail of the pickup truck, a first locator and a second locator. The modular roll bar further includes a second bracket designed to be installed on a passenger's side bed rail of the pickup truck. The second bracket includes a second lower surface associated with the passenger's side bed rail of the pickup truck, a third locator and a fourth locator. The modular roll bar further includes a main bar removably connected to the first locator and the third locator, the main bar designed to extend from the first bracket and the second bracket to an upper surface a cab of the pickup truck. The modular roll bar further includes a first support bar removably connected to the second locator and the main bar, and a second support bar removably connected to the fourth locator and the main bar. The modular roll bar may further include a first base between the first bracket and the main bar, a second base located between the first support bar and the first bracket, a third base located between the main bar and the second bracket, and a fourth base located between the second support bar and the second bracket. The first bracket may include a first flange that is located adjacent to a driver's side inner surface of the driver's side bed rail of the pickup truck when modular roll bar is installed on the pickup truck. The second bracket may includes a second flange that is located adjacent to a passenger's side inner surface of the passenger's side bed rail of the pickup truck when the modular roll bar is installed on the pickup truck. The modular roll bar may further include a cargo rack removably connected to the first support bar and the second support bar, the cargo rack including a cargo surface. The cargo rack may further include a rack light. The cargo rack may further include a support member extending from the cargo surface, the support member designed to limit or prevent cargo from slipping off of the cargo surface. The modular roll bar may further include a light bracket mounted at or near a main bar upper surface. The modular roll bar may further include a light bar extending from the main bar and located above an upper surface of the cab when the roll bar is installed on the pickup truck. The modular roll bar may further include a plate removably connected to the main bar and the first support bar. The plate may include a decorative element.

According to another implementation described herein, a modular roll bar that is designed to be mounted on the bed rails of a pickup truck includes a first bracket designed to be installed on a driver's side bed rail of the pickup truck. The first bracket includes a first lower surface associated with the driver's side bed rail of the pickup truck, a first locator and a second locator. The modular roll bar further includes a second bracket designed to be installed on a passenger's side bed rail of the pickup truck. The second bracket includes a second lower surface associated with the passenger's side bed rail of the pickup truck, a third locator and a fourth locator. The modular roll bar further includes a main bar removably connected to the first locator and the third locator. The main bar is designed to extend from the first bracket and the second bracket to an upper surface a cab of the pickup truck. The modular roll bar further includes a first support bar removably connected to the second locator and the main bar. The modular roll bar further includes a second support bar removably connected to the fourth locator and the main bar. The modular roll bar further includes a first rail configured to be connected to the driver's side bed rail of the pickup truck by a first rail bracket or the first bracket. The modular roll bar further includes a second rail configured to be connected to the passenger's side bed rail of the pickup truck. The modular roll bar further includes a cross bar connected to the first support bar and the second support bar. The modular roll bar further includes a cargo rack connected to the cross bar and to the first rail and the second rail. The cargo rack may be rotatably connected to the cross bar. The cargo rack may be connected to the first rail with a first cargo bar and to the second rail with a second cargo bar. The cargo rack may be connected to the first cargo bar and the second cargo bar using quick release retainers. A light may be mounted to the cargo rack. The modular roll bar may include a first base between the first bracket and the main bar, a second base located between the first support bar and the first bracket, a third base located between the main bar and the second bracket, and a fourth base located between the second support bar and the second bracket. The first bracket may include a first flange that is located adjacent to a driver's side inner surface of the driver's side bed rail of the pickup truck when modular roll bar is installed on the pickup truck.

According to another implementation described herein a modular roll bar that is designed to be mounted on the bed rails of a pickup truck includes a first bracket designed to be installed on a driver's side bed rail of the pickup truck. The first bracket includes a first lower surface associated with the driver's side bed rail of the pickup truck, a first locator and a second locator. The modular roll bar further includes a second bracket designed to be installed on a passenger's side bed rail of the pickup truck. The second bracket includes a second lower surface associated with the passenger's side bed rail of the pickup truck, a third locator and a fourth locator. The modular roll bar further includes a main bar removably connected to the first locator and the third locator, the main bar designed to extend from the first bracket and the second bracket to an upper surface a cab of the pickup truck. The modular roll bar further includes a first support bar removably connected to the second locator and the main bar. The modular roll bar further includes a second support bar removably connected to the fourth locator and the main bar. The modular roll bar further includes a cargo rack detachably connected to the first support bar and the second support bar. The modular roll bar further includes a first plate located between the main bar and the first., support bar and a second plate located between the main bar and the second support bar. The cargo rack may include a light.

A modular roll bar that is designed to be mounted on the bed rails of a pickup truck includes a first bracket designed to be installed on a driver's side bed rail of the pickup truck, the first bracket includes a first lower surface associated with the driver's side bed rail of the pickup truck, a first locator and a second locator. The modular roll bar further includes a second bracket designed to be installed on a passenger's side bed rail of the pickup truck, the second bracket includes a second lower surface associated with the passenger's side bed rail of the pickup truck, a third locator and a fourth locator. A distance is defined by the linear distance between the third locator and the fourth locator, the distance being approximately equal to the linear distance between the first locator and the second locator. A first bar is removably connected to the first locator and the third locator, the first bar designed to extend from the first bracket and the second bracket to an upper surface of the cab of the pickup. A second bar is removably connected to the second locator and the fourth locator. The second bar, when the modular roll bar is installed on the pickup truck, extends from the first bracket and the second bracket to an upper surface of the cab of the pickup truck and is generally parallel to the first bar when the first bar and the second bar extend to the upper surface of the cab of the pickup truck. The second bar is separated from the first bar by about the distance where the first bar and second bar connect to the first bracket and the second bracket. The second bar is nearly adjacent to the first bar when first bar and second bar are generally parallel. A first plate may be located above the first bracket and be removably connected to the first bar and the second bar, and a second plate may be located above the second bracket and be removably connected to the first bar and the second bar. A first base may be located between the first bracket and the first bar, a second base may be located between the second bar and the first bracket, a third base may be located between the first bar and the second bracket, and a fourth base may be located between the second bar and the second bracket. The first bracket may include a first flange adjacent to a driver's side inner surface of the driver's side bed rail of the pickup truck when the modular roll bar is installed on the pickup truck. The second bracket may include a second flange adjacent to a passenger's side inner surface of the passenger's side bed rail of the pickup truck when the modular roll bar is installed on the pickup truck. A light bracket may be installed on the second bar, the light bracket including a light or an aperture for a light. The light bracket may be connected to the first bar. A first rail may extend from the first bracket and a second rail may extend from the second bracket. The first bracket and second bracket may include a section that is located above and is parallel to the bed rail of the pickup truck. A third bracket may be connectable to the driver's side bed rail of the pickup truck and may include a first rail having a first section that, when installed on the pickup truck, is located above and is parallel to the driver's side bed rail of the pickup truck. A fourth bracket may be connectable to the passenger's side bed rail of the pickup truck and may include the a second rail having a second section that, when installed on the pickup truck, is located above and is parallel to the passenger's side bed rail of the pickup truck. A cargo rack may be rotatably and removably connected to the second bar and removably connected to the first rail and the second rail. The cargo rack may be connected to the first rail with a first cargo bar and to the second rail with a second cargo bar. The cargo rack may be connected to the first cargo bar and the second cargo bar using quick release fasteners.

According to another embodiment described herein, a a modular grill guard that is designed to be mounted in front of a vehicle includes a main guard that is installed in the front and center of a vehicle, the main guard including a right bar, a left bar and a first cross member connected to the right bar and the left bar. The modular grill guard further includes a right guard that is removably connected to the right bar, the right guard including a right guard member that protects the right headlight when installed on a vehicle, and a right guard bracket, the right guard bracket providing the removable connection to the right bar, the right guard member extending from the right guard bracket. A left guard that is removably connected to the left bar, the left guard includes a left guard member that protects the left headlight when installed on a vehicle, and a left guard bracket, the left guard bracket providing the removable connection to the left bar, the left guard member extending from the left guard bracket. A first connecting bracket extends from the right bar to connect the modular grill guard to the vehicle. A second connecting bracket extends from the left bar to connect the modular grill guard to the vehicle. The main guard may further includes a grill. The main guard may further include a second cross member connected to the right bar and the left bar. The grill extends between the first cross member and the second cross member. The modular grill guard may further include light brackets and a light connected to the main guard by the light brackets. The light brackets may be connected to a second cross member that is connected to the right bar and the left, bar. Grill members may be connected to the grill. The right bar may include a first land and the left bar may include a second land, the right guard bracket connected to the right bar at the first land and the left guard bracket connected to the left bar at the second land. A first lip may extend around the first land and a second lip extending around the second land. The first connecting bracket and the second connecting bracket may be connectable to the frame of the vehicle. A third connecting bracket may extend from the right bar and a fourth connecting bracket extending from the left bar. The right bar and the left bar may be formed from separate pieces of material. The right bar and the left bar may be formed from a single piece of material. A third cross member and a fourth cross member may be connected to the right bar and the left bar.

### BRIEF DESCRIPTION OF THE DRAWINGS

FIGS. 1A & 1B illustrate and example environment in which the systems, methods technologies and/or techniques, described herein, may be implemented.

FIGS. 2A through 2F illustrate a non-limiting example embodiment of the modular roll bar depicted in FIGS. 1A & 1B as well as example components thereof.

FIGS. 3A through 3D illustrate an alternative non-limiting embodiment of a modular roll bar.

FIGS. 4A & 4B illustrate yet another non-limiting embodiment of a modular roll bar.

FIGS. 5A through 5G illustrate the example environment including the modular roll bar of FIGS. 1A & 1B as well as additional modular components.

FIG. 6 illustrates the example environment including the roll bar of FIGS. 4A and 4B with additional modular components.

FIGS. 7A through 7D illustrate a non-limiting embodiment of a modular grill guard employing the technologies described herein.

### DETAILED DESCRIPTION OF THE DRAWINGS

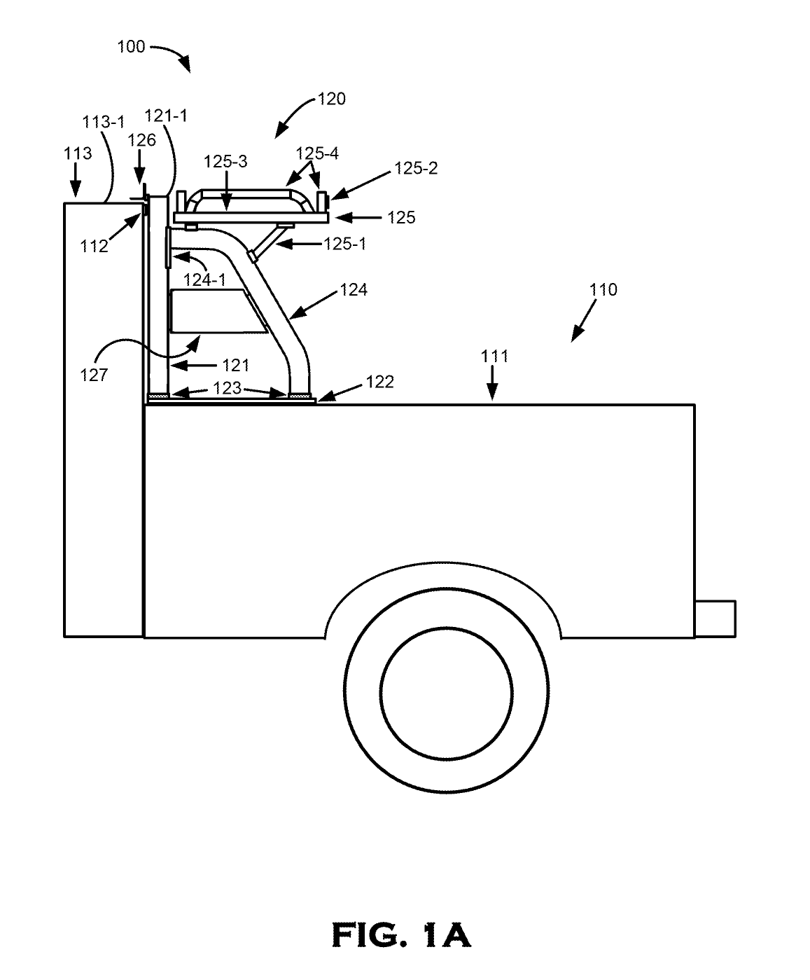

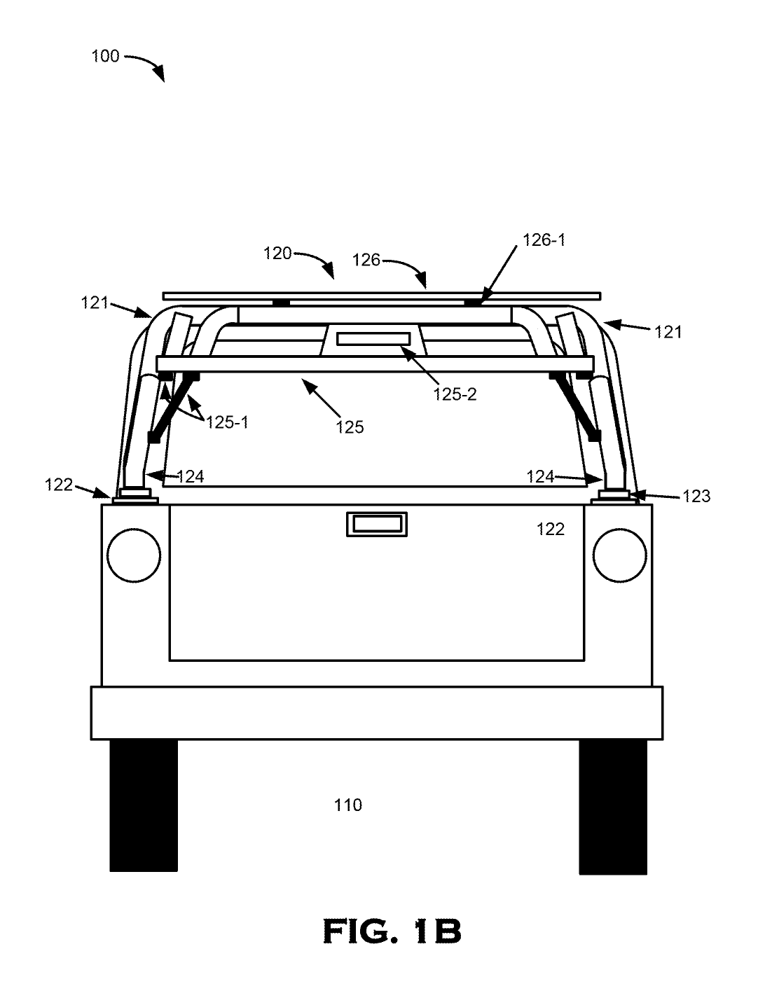

FIGS. 1A to 6 are attached hereto and fully incorporated herein. The following detailed description refers to the embodiments and environments depicted in the accompanying FIGS. 1A to 6. The disclosure herein is not limited to the embodiments or environments depicted herein. The assemblies, systems, methods technologies and/or techniques described herein may be implemented in a variety of different embodiments and in other environments than those depicted in the accompanying Figures without departing from the spirit and scope, of the disclosure herein.

The assemblies, systems, methods technologies and/or techniques described herein may include a modular roll bar that provides support to the cab of a vehicle to which the modular roll bar is mounted. The modular roll bar may include components that are easily installed by a single person and that may be removed from the modular roll bar in the event that the use wishes to remove the modular roll bar, or portions thereof (e.g. light bar, cargo rack, support bar, plate, etc.). The components of the roll bar may connect using, for instance, removable fasteners and may include self-locating features and/or components (hereinafter, “self-locating fixtures”) that may make the components of the modular roll bar easy to install by ensuring that the components are positioned in the correct location. The modular roll bar may include accessories, such as a light bar, a cargo rack, etc. Additionally, the modular roll bar may include a rack light that may be a substitute for a cab light that is covered by the roll bar when installed.

The modular roll bar may include components that are substantially flat such that the modular roll bar may be easily shipped in a single package of a standard size. For example, the cargo rack may lay flat in a package, and main bar may lay flat around cargo rack in the package. The additional components of roll bar may be placed on or around cargo rack so that the roll bar fits within a standard shipping box (i.e. rectangular cardboard packaging). In another embodiment, a first bracket and second bracket may fit easily within a standard shipping package when laid substantially flat, and a bar may be included with the first bracket and second bracket in the standard shipping package.

FIGS. 1A and 1B illustrate an example environment in which the assemblies, systems, methods technologies and/or techniques described herein may be implemented. For example, the environment 100 may include a pickup truck 110 having a modular roll bar 120 (hereinafter “roll bar”) mounted to the bed rails 111 of the pickup truck. The pickup truck 100 may include a cab 113 that may include a cab light 112. The cab 113 may be the passenger compartment of the pickup truck 110. Cab 113 may include an upper surface 113-1, which may correspond to the top of the roof of the cab 113. The cab light 112 may provide light to the bed of the pickup truck 110, alert other drivers of the presence of the pickup truck 110 and/or alert other drivers that the pickup truck 110 is applying its brakes.

Roll bar 120 may include a main bar 121, brackets 122, bases 123, support bars 124, a cargo rack 125, a light bar 126 and plate 127. The components shown in FIGS. 1A and 1B are provided for explanatory purposes only, and the disclosure herein is not intended to be limited to the components provided in FIGS. 1A and 1B. There may be additional components, different components, and/or differently arranged components than what is illustrated in FIGS. 1A and 1B. Also, in some implementations, one or more of the components of the roll bar 120 may perform one or more functions described as being performed by another one or more of the components of roll bar 120.

Roll bar 120 may be installed on the bed rails 111 (i.e. driver's side and passenger's side bed rails) of a pickup truck 110 proximate the cab 113 of the pickup truck 110 to allow roll bar 120 to support the cab 113, such as in the event of a roll over. Roll bar 120 may include a main bar 121 that may span across the bed of the pickup truck 110 from one bed rail to the other. Main bar 121 may include a first end proximate one bed rail 111 (the driver's side) and a second end proximate the other bed rail 111 (the passenger's side). Main bar 121 may extend to the level of and/or be just below or above the upper surface of cab 113 so that, in the event of a roll over, main bar 121 may support the cab 113 by, for instance, keeping it from collapsing (completely or partially), by absorbing impact associated with the roll over, etc. Additionally, or alternatively, accessories may be mounted to main bar 121. Additionally, or alternatively, passengers in the bed of pickup truck 110 may hold on to main bar 121 when standing and/or riding in the bed of pickup truck 110. There are many uses of main bar 121, and a person of ordinary skill in the art will appreciate the variety of uses for which main bar 121 is suited.

Main bar 121 may be formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on main bar 121 by users of the pickup truck (e.g. when holding on, etc.), by the ground or other objects when in the event of a roll over, by the other components of roll bar 120 (e.g. support bar 124, cargo rack 125, light bar 126, etc.) and/or from any other sources associated with using roll bar 120. Main bar 121 may be corrosion resistant (e.g. coated and/or formed from corrosion resistant materials) to allow main bar 121 to be exposed to the environment (e.g. rain, humidity, salt water spray, etc.) without becoming corroded. Main bar 121 may be removably connected (e.g. removable fasteners, like bots, screws, etc.) to bracket 122 (both a driver's side bracket 122 and a passenger's side bracket 122) to be installed on pickup truck 110.

Main bar 121 may include an upper surface 121-1, which may be approximately the same height (i.e. equal height, slightly above, slightly below, etc.) as cab upper surface 113-1 when roll bar 120 is installed on the bed rails 111 of pickup truck 110. Main bar 121 is designed to extend from the driver's side bracket 122 to the main bar upper surface 121-1 and then to the passenger's side bracket 122.

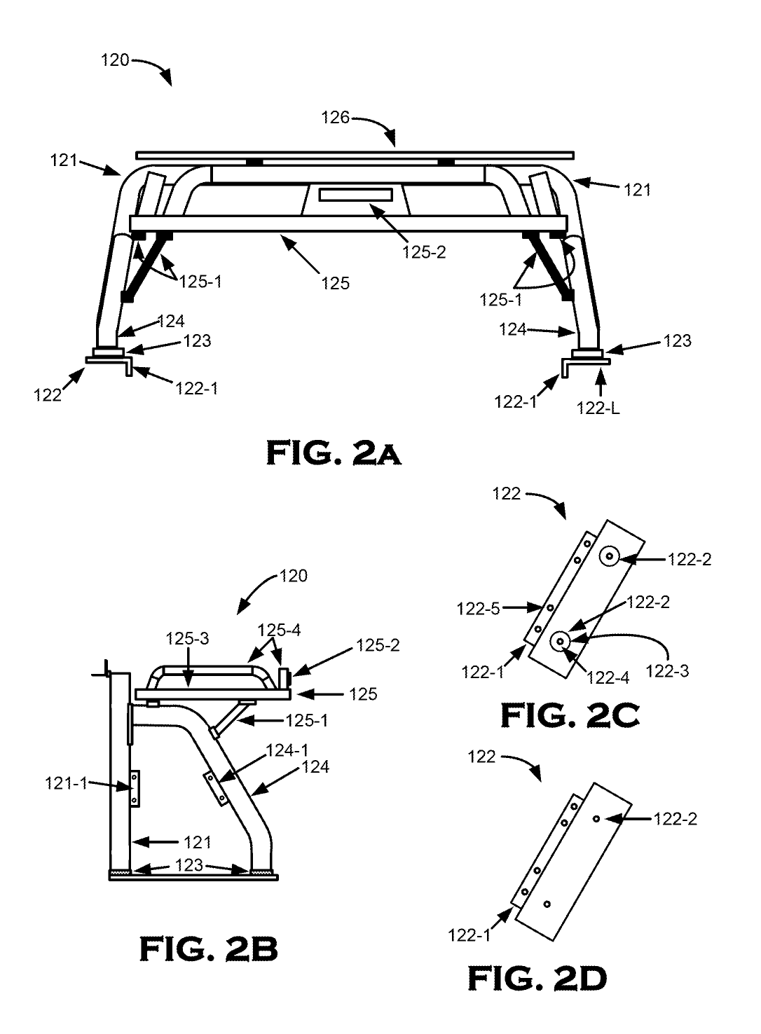

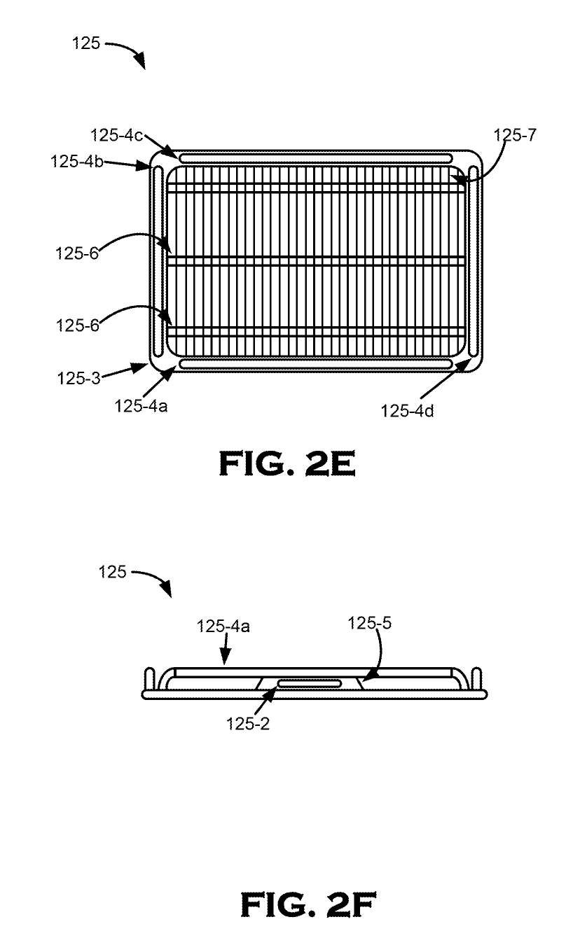

Bracket 122 may be used to install roll bar 120 to the left and right bed rails 111 pickup truck 110. Bracket 122 may include a lower surface that may rest upon the bed rail 111 of pickup truck 110 (i.e. rest directly on the bed rail 111 or indirectly resting on the bed rail, such as on a shim, pad, bracket, etc.) when roll bar 120 is installed on pickup truck 100. Typically, the lower surface (depicted as 122-L in FIG. 2A) is configured as a flat surface that rests on the bed rail of a pickup truck. Bracket may include an upper surface, opposite lower surface, on which main bar 121, support bars 124, and/or bases 123 may be located when roll bar 120 is installed on pickup truck 110.

As shown in FIGS. 2C and 2D, bracket 122 may include one or more locators 122-2 that may allow a user to easily install the components of roll bar 120 in the correct position. For instance, locators 122-2 may include one or more apertures 122-4 (clearance holes, threaded holes, etc.) that may correspond to one or more apertures (not shown) in main bar 121, support bars 124 and/or bases 123. A fastener may be used to removably connect bracket 122 to main bar 121, support bars 124 and/or bases 123, such as by passing through the apertures in bracket 122 and the other components. Locators 122-2 may be features that locate main bar 121, support bars 124, bases 123, etc. relative to bracket. For instance, each bracket 122 (i.e. driver's side and passenger's side) may include a first locator that locates the main bar 121 and a second locator that locates the support bar 124. In one embodiment, apertures are located in the center of the main bar 121 (at each end where main bar 121 connects to the brackets 122), at the center of support bar 124 where is mounts to bracket 122, and at the center of the bases. These apertures may aligned with an locators 122-2 in bracket 122, which positions these components. For example, a fastener may extend from underneath bracket 122 (the surface of bracket that rests on bed rail 111) through the bracket 122, through a base 123 and into a threaded aperture in main bar 121 or support bar 124. Additionally, or alternatively, locators 122-2 may include protrusions 122-3 (e.g. material that stands proud of upper surface of bracket 122) that may correspond to an inner diameter of main bar 121, support bars 124 and/or bases 123. The protrusions 122-3 may fit within the inner diameter of one or more of these components to locate the components. Bracket 122 may be fastened to the bed rails of a pickup truck, such as by fasteners that pass through apertures 122-5 in flange 122-1, apertures that pass from upper surface to lower surface of bracket 122 (not shown), by passing a fastener from underneath bed rail 111 through apertures 122-4 and into another component (e.g. main bar 121, support bar 124, base, etc.) etc.

Bracket 122 may be formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on bracket 122 by, for instance, the other components of roll bar 120 (e.g. main bar 121, support bar 124, bases 123, etc.), that result from forces applied to the roll bar 120 (e.g. from a roll over, from someone pulling on roll bar, loads placed on cargo rack 125, etc.) and/or from any other sources associated with using roll bar 120. Bracket 122 may be corrosion resistant (e.g. coated and/or formed from corrosion resistant materials) to allow bracket 122 to be exposed to the environment (e.g. rain, humidity, salt water spray, etc.) without becoming corroded. Bracket 122 may be removably connected (e.g. removable fasteners, like bots, screws, etc.) to the bed rail 111 of pickup truck 110 using, for instance, fasteners (e.g. screws, bolts and nuts, threaded studs and nuts, etc.). Bracket 122 may include a flange (depicted as 122-1 in FIG. 2A) that may extend from upper surface of the bed rail 111 down along a corresponding flange of bed rail inside of the bed of pickup truck 110. Bracket may include apertures in this flange to allow bracket 122 to be mounted through the flange of the bed rail 111 of pickup truck 110. Additionally, or alternatively, bracket 122 may be mounted to the upper surface of bed rail 111 on which bracket 122 is located, such as by using fasteners to secure bracket to the upper surface of bed rail 111.

Bases 123 may be located between main bar 121 and bracket 122 and/or between bracket 122 and support bars 124. Bases 123 may be formed from any material, such as elastic material (e.g. polymers, natural or synthetic, etc.) that may keep the components between which bases 123 are placed from rubbing, making contact, making noise, etc. and/or formed from, for instance, a hardened plastic, metals, etc. Bases 123 may include self-locating features that may help locate the components between which bases 123 are placed. For example, a protrusion from bracket 122 may fit within a first inner diameter of base 123 to locate base 123. Additionally, or alternatively, a second inner diameter (which may be the same as, formed as a part of, or separate from first inner diameter) of base 123 may correspond to an outer diameter of main bar 121 and/or support bar 124. Additionally, or alternatively, bases 123 may minimize and/or eliminate any gaps that may exist between bracket 122 and main bar 121 and/or bracket 122 and support bar 124, which may give the roll bar a better appearance.

Support bar 124 may provide structural support to main bar 121 to absorb a portion of the loads to which main bar 121 is exposed. Additionally, or alternatively, accessories, such as cargo rack 125, light bar 126, etc. may be mounted to support bar 124. Support bar 124 may be formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on support bar 124 by the main bar 121 (e.g. during a roll over, etc.) the other components of roll bar 120 (e.g. cargo rack 125, etc.) and/or other forces applied to the roll bar 120 (e.g. from someone pulling on roll bar, etc.) and/or from any other sources associated with using roll bar 120. Support bar 124 may be corrosion resistant (e.g. coated and/or formed from corrosion resistant materials) to allow support bar 124 to be exposed to the environment (e.g. rain, humidity, salt water spray, etc.) without becoming corroded. Support bar 124 may have a first end that is removably connected to bracket 122 and/or base 123 (e.g. in the same and/or similar way as main bar 121 is connected to bracket 122 and/or base 123) and a second end that is removably connected to main bar 121. For example, and not limitation, second end may include a support bracket 124-1 (that may be permanently installed, such as by welding, or removably installed to support bar 124) that connects support bar 124 to main bar 121. Support bracket 124-1 may include self-locating features such as, for example, a surface that mates with a shape and/or dimension (e.g. a tubular shape, flat shape, curve, etc.) of main bar 121 and/or an aperture that may align with an aperture or threaded stud in main bar 121 so that one or more fasteners may connect support bracket 124-1 to main bar 121 (e.g. through an aperture in support bracket 124-1 and into a threaded aperture in main bar 121, or a threaded stud extending from main bar 121 through the aperture in support bar 124 and retained by a nut, etc.).

Cargo rack 125 may provide a horizontal surface 125-3 on which any sort of cargo (e.g. luggage, outdoor gear, coolers, etc.) may be placed to transport the cargo. As shown in the figures, cargo rack may correspond to a tubular design that includes a horizontal surface 125-3 (not shown in detail) that corresponds to, for example, a solid surface, such as a plate, or a non-solid surface, such as a grate, etc. Cargo rack 125 may include sides 125-4 that may limit and/or prevent cargo from sliding off of the horizontal surface 125-3. Cargo rack 125 may be formed in any shape and/or design. Cargo rack 125 may be formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on cargo rack 125 by, for example, the loads placed on cargo rack (e.g. outdoor equipment, luggage, etc.) as well as other forces applied to the cargo rack 125 (e.g. wind forces, forces from some loading and/or unloading cargo rack, etc.) Cargo rack 125 may be corrosion resistant (e.g. coated and/or formed from corrosion resistant materials) to allow cargo rack 125 to be exposed to the environment (e.g. rain, humidity, salt water spray, etc.) without becoming corroded.

Cargo rack 125 may be removably connected to roll bar 120 to allow cargo rack 125 to be easily installed and/or removed as needed. As shown in FIGS. 1A and 1B, cargo rack 125 may be installed using rack brackets 125-1 that connect cargo rack 125 to support bar 124 (e.g. using fasteners that connect to, for instance, threaded apertures in support bar 124, brackets (not shown) mounted to support bar 124 and/or brackets mounted cargo rack, etc.). While rack brackets 125-1 are shown as being connected to each support bar 124 in two places, cargo rack 125 may be connected to other components of roll bar 120, such as main bar 121, light bar 126, etc. Cargo rack 125 may further include a rack light 125-2 that may provide a substitute for cab light 112, which may be covered by cargo rack 125, main bar 121 and/or other components of roll bar 120. Rack light 125-2 may be connected to the wiring of the pickup truck 110. Cargo rack 125 as well as other components of roll bar (e.g. main bar, support bar, etc.) may include passages through which wiring for rack light 125-2 may be routed so that the wiring is hidden from view.

Light bar 126 may provide a surface on which lights (e.g. off road lighting, additional cargo lighting, etc.) may be installed. Light bar 126 may be removably connected to main bar 121, such as by using brackets 126-1 extending from main bar 121 as well as fasteners that connect the bracket 126-1 to light bar 126, and/or other components of roll bar 120, such as cargo rack 125. In the embodiment depicted in FIGS. 1A through 2B, the light bar 126 is located slightly above the upper surface 113-1 of cab 113, which may be useful for mounting lights that shine above the upper surface 113-1. In this embodiment, brackets 126-1 are located at or near (slightly above or below) the upper surface 121-1 of main bar 121. Light bar 126 may include, for example, channels through which wiring may be routed (for example, into the passages referenced above regarding wiring for rack light 125-2), mounting locations for lights, etc.

Plate 127 may be located between support bar 124 and main bar 121 and may provide decorative features to roll bar 120 (e.g. trademarks of manufacturer, outdoor scenes, etc.). For example, decorative elements may be placed on the plate 127, which may be seen by observers standing on either side of pickup truck 110. Additionally, plate may include a stack of three plates in which the middle plate has one or more colors that are seen through cutouts (e.g. decorative cutouts) in the outer plates. Plate 127 may also, or alternatively, provide structural strength to roll bar 120 by stiffening the connection between main bar 121 and support bar 124. Plate 127 may be connected to main bar 121 and support bar 124 using, for example, brackets extending from plate, main bar 121 and/or support bar 124 and fasteners and/or welding. For example, as depicted in FIG. 2B, plate 127 may connect to a first bracket 121-1 in main bar 121 and a second bracket 124-1 in support bar 124 using fasteners that extend through apertures in first bracket 121-1, second bracket 124-1 and plate 127.

FIG. 2A illustrates roll bar 120 of FIGS. 1A and 1B. Because the pickup truck 110 is not shown in FIG. 2A, flanges 122-1 may be seen in FIGS. 2A and 2B. Flanges 122-1 may extend from brackets 122 and align with the inner surface of the bed rails of a pickup truck. Flanges 122-1 may be pressed against the inner surface of the bed rails of a pickup truck to align bracket (i.e. by aligning it against the inner rail). Flanges 122-1 may also, or alternatively, provide a surface through which fasteners may connect bracket 122 to a pickup truck (i.e. a fastener may pass through an aperture in flange 122-1 and the inner surface of the bed rail to connect the bracket 122 to the pickup truck). The description herein provides a roll bar that may be easily installed by a single person in a variety of ways. For instance, brackets 122 may be placed on the bed rails 111 of a pickup truck 110. Main bar 121, support bar 124 and bases 123 may be connected to brackets 122 while they are resting on bed rails. After main bar 121, support bar 124 and bases 123 are connected to brackets 122, brackets 122 may be located on bed rails 111 and then fastened to the pickup truck 110. Thereafter, light bar 126, plates 127 and cargo rack 125 may be easily installed.

FIGS. 2E and 2F illustrate the example embodiment of cargo rack 125 used in connection with roll bar 120. In this embodiment, cargo rack 125 may have a frame 125-3 that extends around the perimeter of cargo rack 125. Cargo rack 125 may also include cargo support members 125-4 (shown as 125-4a through 125-4d) which may extend from frame 123 and may be used to tie down cargo that is loaded on cargo rack, may prevent cargo from sliding off of cargo rack 125, etc. Cargo rack 125 may further include cross members 125-6, which may be connected to frame and may support the loads of cargo placed on cargo rack 125, including cargo on cargo surface 125-7. Cargo surface 125-7 may provide the surface on which cargo may be placed to secure and/or transport the cargo. While cargo surface 125-7 is shown as a wire frame, cargo surface 125-7 may be formed from any material (e.g. steel frame, steel grate, aluminum frame or grate, solid plate, etc.). Further, while frame 125-3, cargo support members 125-4, and cross members are depicted as formed from metal tubing (e.g. aluminum tube, steel tube, etc.), these components may be formed from any type of material that may support the loads of cargo and may withstand outdoor conditions (i.e. precipitation, freezing temperatures, hot temperatures, etc.). As depicted in FIG. 2F, cargo rack 125 may also include rack light 125-2, which may be secured to frame 125-3 and cargo support member 125-4a using rack light bracket 125-5.

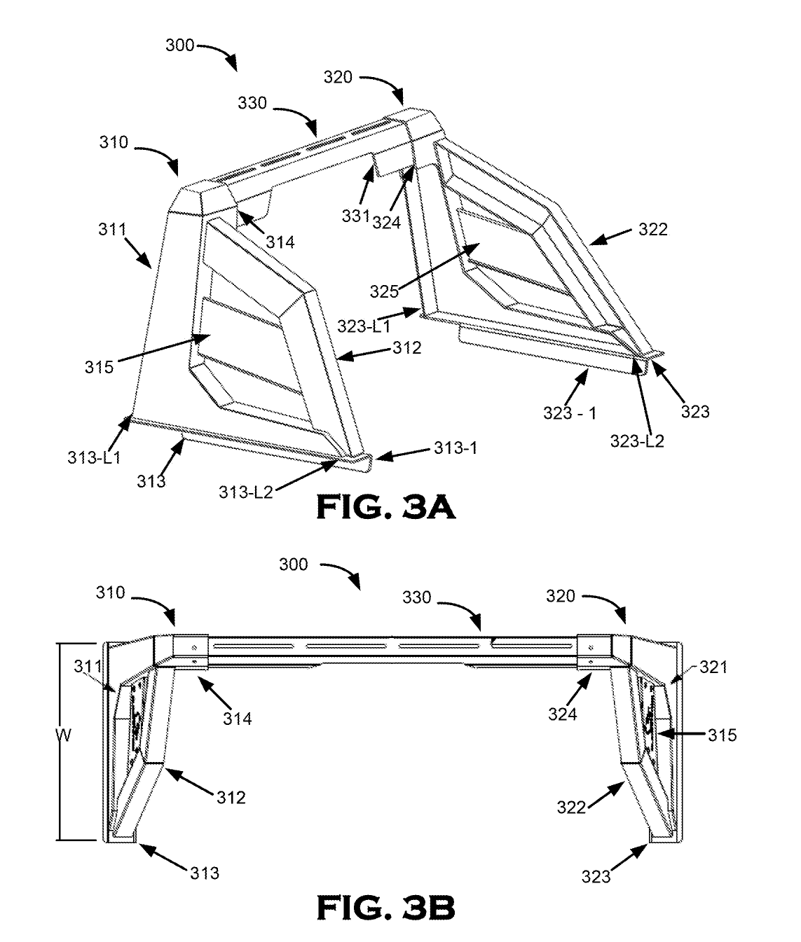

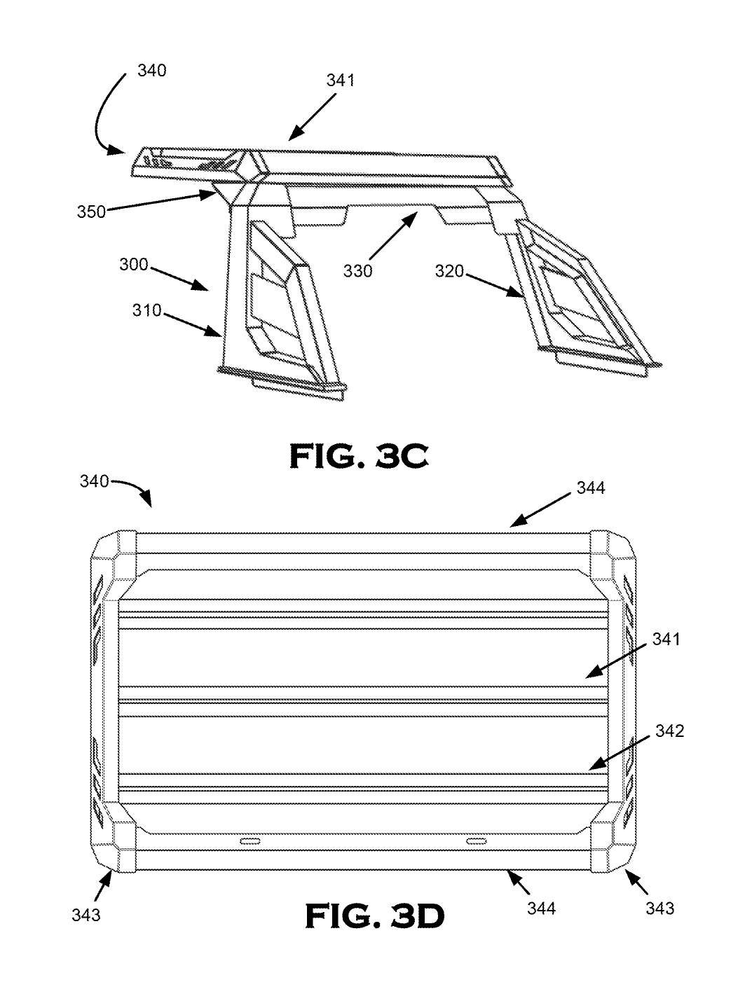

FIGS. 3A and 3B illustrate an alternative embodiment of a modular roll bar. The roll bar 300 may include a first bracket 310, a second bracket 320 and a bar 330. Roll bar 300 may include additional components, different components, and/or differently arranged components than what is illustrated in FIGS. 3A and 3B. Also, in some implementations, one or more of the components of the roll bar 300 may perform one or more functions described as being performed by another one or more of the components of roll bar 300.

Similar to roll bar 120, roll bar 300 may be installed on the bed rails (i.e. driver's side and passenger's side bed rails) of a pickup truck proximate the cab of the pickup truck to allow roll bar 300 to support the cab, such as in the event of a roll over. Roll bar 300 may include a first bracket 310 and a second bracket 320 that may connect (e.g. removable fasteners, welding, etc.) to the bed rails of the pickup truck and a bar 330 that may be connected to the first bracket 310 and second bracket 320 and that may span across the bed of the pickup truck when installed. Bar 330 may include a first bracket end that is connected to (e.g. mechanical fasteners, welding, etc.) the first bracket 310 and a second bracket end that is connected to the second bracket 320. Bar 330 may extend to the level of and/or above the upper surface of the cab of a pickup truck so that, in the event of a roll over, bar 330 may support the cab by, for instance, keeping it from collapsing (completely or partially), by absorbing impact associated with the roll over, etc. Additionally, or alternatively, accessories (e.g. lights, light bars, cargo racks, etc.) may be mounted to bar 330. Additionally, or alternatively, passengers in the bed of a pickup truck may hold on to bar 330 when standing and/or riding in the bed of the pickup truck. There are many uses for bar 330, and a person of ordinary skill in the art will appreciate the variety of uses for which bar 330 is suited.

Bar 330 may be formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on bar 300 by users of the pickup truck (e.g. when holding on, etc.), by the ground or other objects when in the event of a roll over, by the other components of roll bar 300 and/or from any other sources associated with using roll bar 300. Bar 300 may be corrosion resistant (e.g. coated and/or formed from corrosion resistant materials) to allow bar 300 to be exposed to the environment (e.g. rain, humidity, salt water spray, etc.) without becoming corroded. Bar 300 may be connected to first bracket 310 and second bracket 320 to be installed on pickup truck. Bar 330 may include a light reveal, 331, which corresponds to a an area of bar 330 where bar is thinner (i.e. an absence of material) to allow a cab light to be seen.

First bracket 310 may connect bar 330 to the driver's side bed rail of a pickup truck and may provide support to bar 330 (e.g. absorb some or all of the static and/or dynamic loads imparted on bar 330). First bracket 310 may include first member 311, second member 312, bracket 313, bar interface 314 and plate 315. First bracket 310 may include additional components, different components, and/or differently arranged components than what is illustrated in FIGS. 3A and 3B. Also, in some implementations, one or more of the components of first bracket 310 may perform one or more functions described as being performed by another one or more of the components of first bracket 310.

First bracket 310 may be formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on first bracket 310 by users of the pickup truck (e.g. when holding on, etc.), by the bar 330 in the event of a roll over, by the other components of roll bar 300 and/or from any other sources associated with using roll bar 300. First bracket 310 may be corrosion resistant (e.g. coated and/or formed from corrosion resistant materials) to allow first bracket 310 to be exposed to the environment (e.g. rain, humidity, salt water spray, etc.) without becoming corroded. First bracket 310 may be connected to bar 330 and the bed rail of a pickup truck.

First member 311 may extend from bar interface 314 to bracket 313. As shown in FIG. 3A, first member 311 may extend along a majority of an upper surface of bracket 313 from a first location 313-L1 that, when installed, is near the cab of the pickup truck to a second location 313-L2 that is more than about half of a width W of bracket 313 (as defined by the length of line from front to back of a pickup truck along lower surface of bracket 313 where bracket rests on the bed rails of a pickup truck), the second location corresponding to an area where second member 312 meets bracket 313. Bar interface 314 may connect to bar 330 by providing, for instance, an aperture or other open area into which bar 330 is inserted (i.e. bar 330 may slide into first bracket 310, such in a c-channel configuration in which bar interface 314 encompasses three sides of bar 330, and mechanical fasteners pass through bar interface 314 and bar 330 to secure bar 330 to bar interface 314). Bar interface 314 may be an area of first bracket 310 in which first bracket 310 is connected to bar 330. For example, in the embodiment shown in FIGS. 3A and 3B, bar interface 314 (and 324) may correspond to an area in which bar 330 is nested inside of first bracket 310 (and second bracket 320) such that mechanical fasteners and/or welding may secure bar interface 314 to bar 330. Second member 312 may extend from first member 311 at an area at or near bar interface 314 to bracket 313. Second member 312 may connect to bracket 313 at an area at or near second location 313-L2. At or near second location 313-L2, second member 312 may be connected (e.g. welding, fasteners, etc.) to bracket 313 and/or first member 311. As shown in FIGS. 3A and 3B, second member 312 may overlap a portion of first member 311 at or near second location 313-L2. Second member 312 may provide support to bar 330 by distributing the loads transferred to first bracket 310 from bar 330 and bar interface 314. These loads may be shared by first member 311 and second member 312, and the structural arrangement may facilitate the sharing of these loads and/or the ease of installation of roll bar 300.

Similar to bracket 122, Bracket 313 may extend along the rail of a pickup truck and may connect first bracket 310 to the bed rail of a pickup truck. Bracket may include a flange 313-1 that may, similar to flange 122-1, overhang the inside of the bed rail of a pickup truck and provide a surface used to connect first bracket 310 to the inside flange of a bed rail of a pickup truck. Bracket 313 may include a lower surface that is intended to rest on the bed rails of the pickup truck on which roll bar 330 is installed. A plate 315 may extend from first member 311 to second member 312 and may, similar to plate 127, provide decorative features to roll bar. Plate 315 may be connected to first member 311 and second member 312 using, for example, removable fasteners that connect directly to first member 311 and second member 312 and/or brackets extending therefrom, welding to first and/or second member, etc. Plate 315 may also, or alternatively, provide structural support to roll bar 300.

Second bracket 320 may connect the bar 330 to the passenger side bed rail of a pickup truck and may include the same components as and/or similar components to first bracket 310, such as third member 321 (like first member 311) (extending from third location 323-L1 to fourth location 323-L2 on bracket), fourth member 322 (like second member 312), bracket 323 (which may include flange 323-1), bar interface 324 and plate 325. The components of second bracket 320 may function the same as, or similar to, the similar components of first bracket 310.

In one embodiment, first member 311, second member 312, bracket 313, and bar interface 314 of first bracket 310 may be formed from a single piece of material and/or may be welded together to form a one-piece design. Similarly, second bracket 320 may be a one-piece design when third member 321, fourth member 322, bracket 323 and bar interface 324 of second bracket 320 are formed from a single piece of material and/or welded together to form a one-piece design. Also in this embodiment, bar 330 may fit within (e.g. be a press fit, slip fit, etc.) corresponding apertures of bar interfaces 314 and 324 to promote easy installation. In this embodiment, the roll bar 300 may be easily installed by placing bar 330 in the apertures of the bar interfaces 314 and 324 and then placing first bracket 310 and second bracket 320 on opposing bed rails of a pickup truck proximate the cab. First bracket 310, second bracket 320 and/or bar 330 may be adjusted while resting on the bed rails of the pickup truck until the roll bar 300 is in a suitable position for installation. At that point, first bracket 310 and second bracket 320 may be connected to (e.g. mechanical fasteners, welding, etc.) the bed rails of the pickup truck as described herein (i.e. mechanical fasteners secure first bracket 310 and second bracket 320 to the bed rails of the pickup truck, such as via flanges 313-1 and 323-1), and bar 330 may be secured to (e.g. mechanical fasteners, welding, etc.) first bracket 310 and second bracket 320. Also in this embodiment, first bracket 310 and second bracket 320 may be laid flat (i.e. first member and second member of each may be placed in a horizontal position) in a standard shipping package and bar 330 included along first bracket 310 and second bracket 320 to make roll bar 300 fit easily within the standard shipping package.

FIG. 3C illustrates the roll bar 300 including a roof rack 340. Roof rack 340 may provide a surface 341 on which cargo may be placed. When roll bar 300 is installed on the bed rails of a pickup truck, roof rack 340 may extend over the upper surface of the cab of a pickup truck and provide a surface 341 on which cargo may be placed. The roof rack 340 may be an alternative to cargo rack 125 that may allow cargo to be placed over the cab of the pickup truck rather than over the bed of a pickup truck. Roof rack 340 may be connected to roll bar 300 with brackets 350, such as by using screws, bolts, quick release pins, etc. Brackets 350 may connect using one or more of the same fasteners used to connect bar 330 to first bracket 310 and/or second bracket 320. Additionally, or alternatively, brackets 350 may use different fasteners from those used to connect bar 330 to first bracket 310 and/or second bracket 320, which may allow roof rack 340 and brackets 350 to be removed without disassembling and/or disconnecting any portions of roll bar 300. FIG. 3C depicts brackets 350 connected to first bracket 310 and second bracket 320 to connect roof rack 340 to roll bar 300. Additionally, or alternatively, brackets 350 may be used to connect roof rack 340 to bar 330. Additionally, or alternatively, roof rack 340 may be connected directly to roll bar using, for instance, bolts to connect bar 330 to roof rack 340, first bracket 310 to roof rack 340 and/or second bracket 320 to roof rack 340, etc., in which case brackets 350 may be omitted. As depicted in FIG. 3D, roof rack 340 may include cross members 342, which may be used to provide the surface 341 on which cargo is placed. Roof rack 340 may further include rails 343, which may be connected to cross members 342 and to end members 344. As shown in FIG. 3C, rails 343 may connect to brackets 350 to connect roof rack 340 to roll bar 300. As described herein, roof rack 340 may be connected to roll bar 300 in other ways. End members 344 may be raised slightly above cross members 342. In this configuration, end members 344 may prevent cargo from slipping off of surface 341, may provide structure to which cargo may be secured, etc. Cross members 342, rails 343 and end members 343 may be connected (e.g. removably connected, such as by screws, bolts, etc. or permanently connected, such as by welding, etc.) to create roof rack 340. In one embodiment, these components are detachably connected using fasteners, which allows roof rack to be easily shipped to consumers.

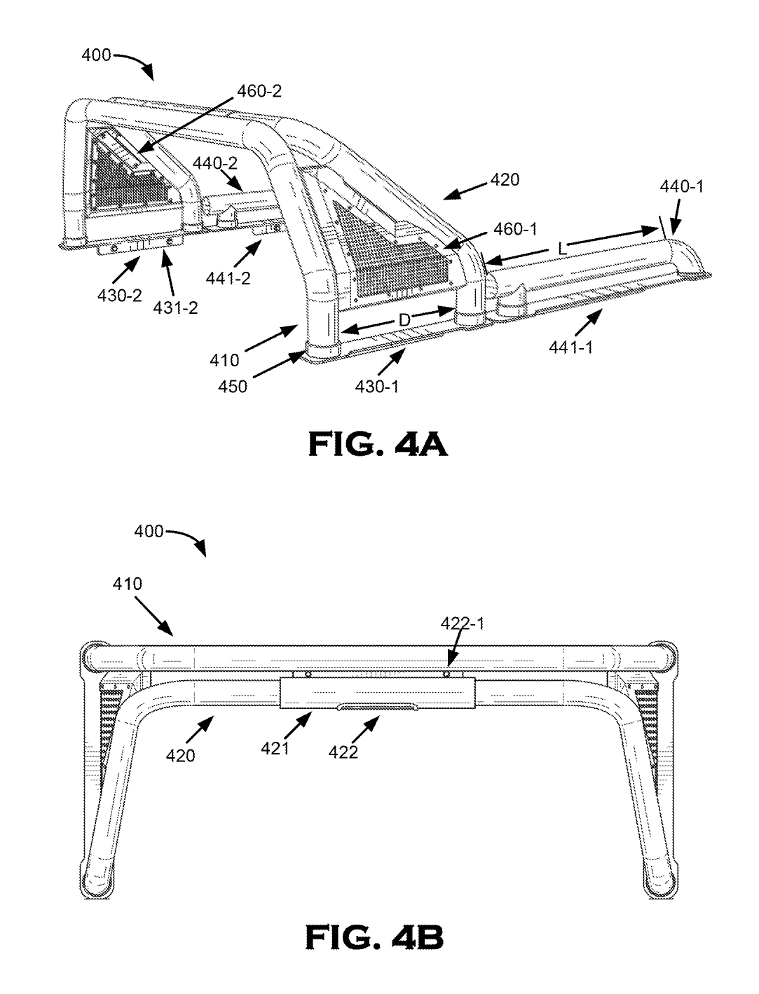

FIGS. 4A and 4B illustrate an alternative embodiment of a modular roll bar. The roll bar 400 may include a first bar 410, a second bar 420, a pair of mounting brackets 430 (referred to as mounting bracket 430 or specifically as mounting bracket 430-1 for the driver's side and mounting bracket 430-2 for the passenger's side), a pair of rails 440 (referred to as rail 440 or specifically as rail bracket 440-1 and rail bracket 440-2 for the driver's side and passenger's side, respectively), each having a rail bracket 441 (referred to as rail 441 or specifically as rail 441-1 and 441-2 for driver's side and passenger's side, respectively), bases 450 and plate 460. Roll bar 400 may include additional components, different components, and/or differently arranged components than what is illustrated in FIGS. 4A and 4B. Also, in some implementations, one or more of the components of the roll bar 400 may perform one or more functions described as being performed by another one or more of the components of roll bar 400.

Similar to roll bar 120, roll bar 400 may be installed on the bed rails (i.e. driver's side and passenger's side bed rails) of a pickup truck proximate the cab of the pickup truck to allow roll bar 400 to support the cab, such as in the event of a roll over. Roll bar 400 may include a first mounting bracket 430-I and a second mounting bracket 430-2 (also referred to as mounting brackets 430 without regard to driver's side or passenger's side) that may connect (e.g. removable fasteners, welding, etc.) to the bed rails of the pickup truck. As shown in FIG. 4A, mounting brackets 430 may include flanges 431 (depicted as flange 431-2 to indicate passenger's side) that may overhang the inside of the bed rail of a pickup truck and that may be used to fasten mounting brackets 430 to the pickup truck, in the same way that flanges 122-1 connect roll bar 120 to the inside surface of the bed rail of a pickup truck. Mounting brackets 430 may be the same as, or similar to, mounting brackets 122 of roll bar 120 (may have locators, flanges, etc.). For instance, mounting brackets may include locators (apertures, protrusions, etc.) that may be used to locate first bar 410 and second bar 420 in the way that mounting brackets 122 include these items to locate main bar 121 and support bars 124.

Roll bar 400 may include a first bar 410 that may span the width of the pickup truck and may provide support to the cab of the pickup truck, such an in the event of a rollover. First bar 410 may extend from first mounting bracket 430-1 to a height that is approximately equal to the height of the upper surface of the cab a pickup truck (113-1 in FIG. 1A) and then to the second mounting bracket 430-2. First bat 410 may be located in close proximity to (i.e. almost touching, within about six inches from, etc.) the cab of a pickup truck when installed. Bases 450 may function like bases 123 and may be located between first bar 410 and first mounting bracket 430-1, between first bar second mounting bracket 430-2, between second bar 420 and first mounting bracket 430-1/second mounting bracket 430-2, between rails 440 and rail brackets 441/mounting brackets 430, etc.

Roll bar 400 may further include a second bar 420 that may span the width of the pickup truck and may provide support to the cab of the pickup truck, such as in the event of a rollover. Second bar 420 may extend from the first mounting bracket 430-1 to a height that is approximately equal to the height of the upper surface of the cab of a pickup truck, may maintain that height for about the length of the cab, and may have a height that is about equal to the height of first bar 410 (i.e. in the area of first bar 410 where first bar 410 is generally parallel to the upper surface of the cab of the pickup truck) when installed. When installed, a distance D (from about six inches to about four feet, as measured from the center of the first bar and the second bar, from the locators, etc.) separates first bar 410 and second bar 420 at the mounting brackets 430. Second bar 420 extends from the mounting brackets 430 towards first bar such that, when first bar and second bar have extended to a height that is approximately equal to the upper surface of the cab of a pickup truck, first bar 410 and second bar 420 are nearly adjacent (less from touching to about three inches apart). Second bar 420 may include a light 422 that, similar to light 125-2, may be located in line with a cab light (such as cab light. 112) when roll bar 400 is installed. Light bracket 421 may be installed on (e.g. welded on, fasteners may located, may surround second bar 420 and be retained in place with fasteners, etc.) second bar 420 and may include an aperture in which light 422 is located. Light bracket 421 may also, or alternatively, be used to connect first bar 410 and second bar 420 (i.e. light bracket may extend above or below first bar 410 and fasteners may pass through light bracket 421 and into threaded apertures in first bar 410, a retainer on the opposite side of first bar 410, first bar 410 may have small brackets extending from the first bar that include apertures that line up with apertures 422-1 in light bracket 422 and are secured with a fastener, etc.).

First bar 410 and second bar 420 may connect to mounting brackets 430 in the same or similar ways as main bar 121 and support bar 124 connect to mounting brackets 122 of roll bar 120. For example, bases 450, which are the same as or similar to bases 123, may be located between first bar 410 and mounting brackets 430 and between second bar 420 and mounting brackets 430.

Roll bar 420 may further include a plate 460 (460-1 for driver's side, 460-2 for passenger's side) connected to first bar 410 and second bar 420 (i.e. fastened to first bar 410 and second bar 420 with screws or bolts that are threaded into threaded apertures in first bar 410 and second bar, etc.). Plate 460 may be located above mounting brackets 430 in the area where second bar 420 and first bar 410 extend from mounting brackets 430 to a height that is approximately equal to the height of the upper surface of the cab of a pickup truck. Plate 460 may include a decorative mesh center or other decorative characteristics (words, symbols, artwork, etc.).

Roll bar 400 may further include rails 440 (driver's side rail 440-1, passenger's side rail 440-2 or generically rails 440). Rails 440 may include rail brackets 441 (driver's side rail bracket shown as 441-1 and passenger side shown as 441-2) that connect rails 440 to the bed rails of a pickup truck. Rail brackets 441 may have substantially the same design as mounting brackets 430 (i.e. mounting flanges, like flanges 431, protrusions, apertures for mounting, etc.). While rail brackets 441 are depicted as part of rails 440 that is separate from mounting brackets 430, rail brackets 441 may be formed as a part of mounting brackets 430, and rails may extend from mounting brackets 430. Rails 440 may extend from mounting brackets 430 or rail brackets 441 to a height (usually less than about one foot) above the bed rails of a pickup truck when installed and may include a length L for which rails are generally parallel to the bed rails of the pickup truck. Rails 440 may provide a decorative appeal, may provide a surface on which other items may be mounted, and or may serve as tie downs, etc. As will be further described herein, other components may be mounted to rails, such as a cargo rack. Rails 440 may connect to rail brackets 441 and/or mounting brackets 430 in the same/similar ways that first bar 410 and second bar 420 connect to mounting brackets. Alternatively, rails 440 may be welded to rail brackets 441 or mounting brackets 430, or may have a combination of welding and other connection methods described herein.

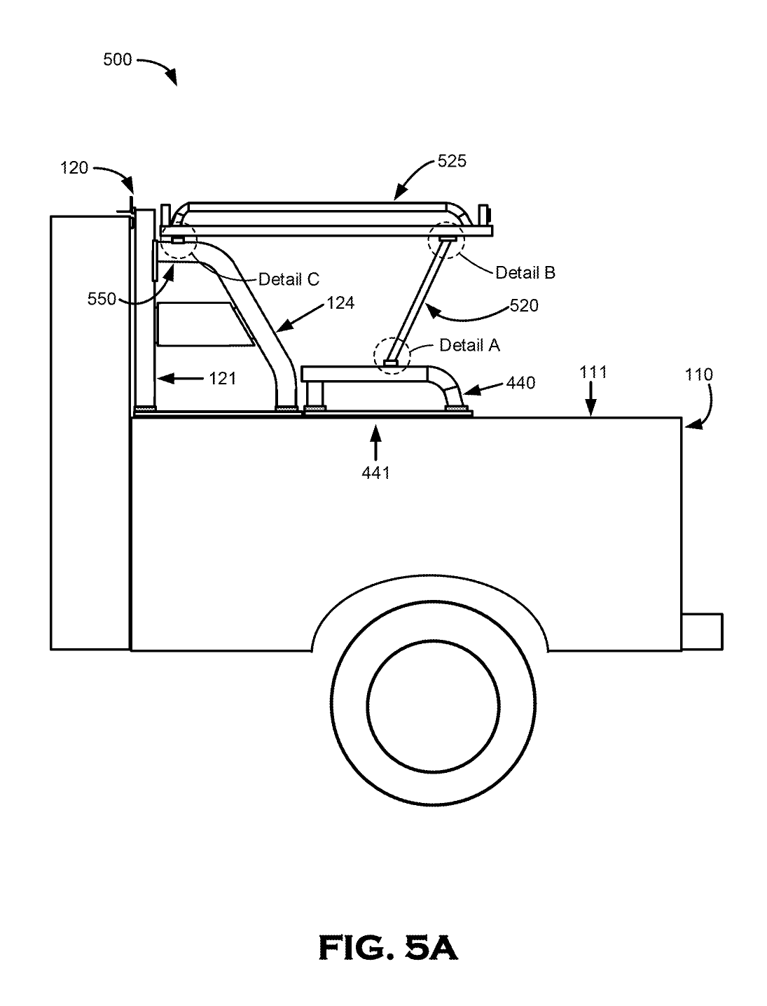

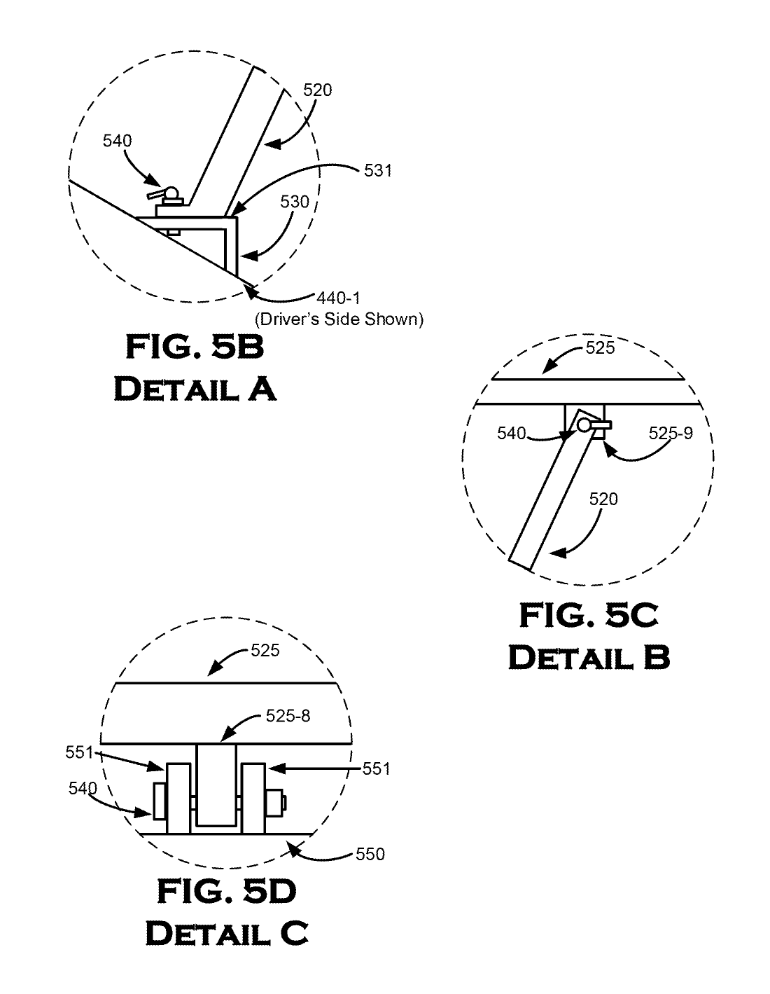

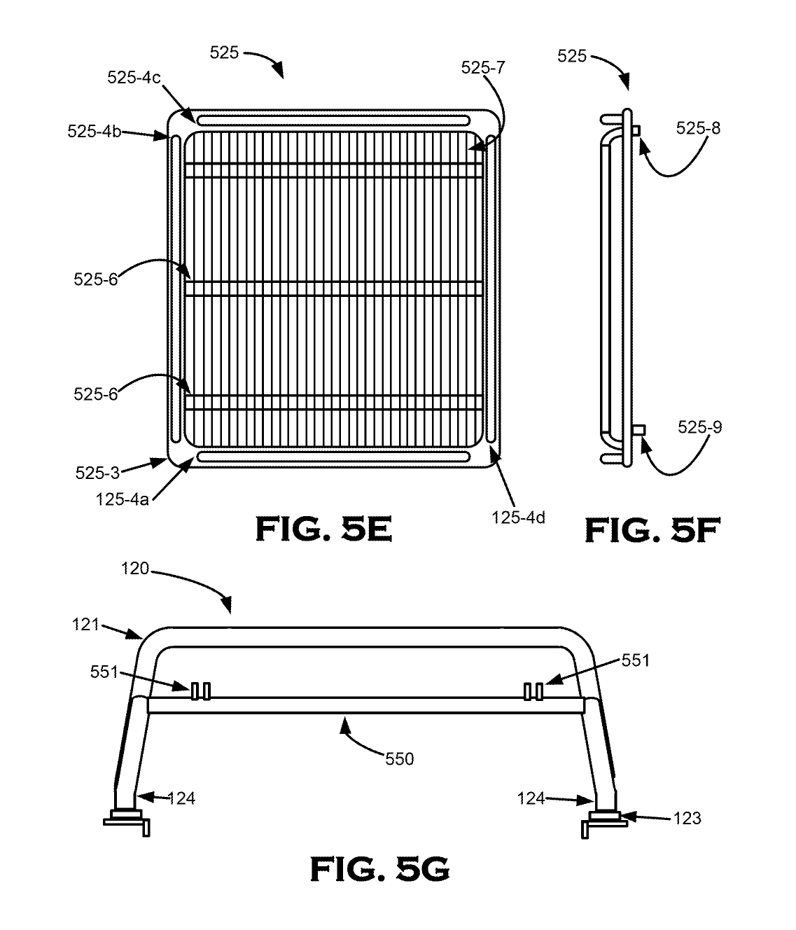

FIGS. 5A through 5G illustrate and environment 500 including roll bar 120 installed on a pickup truck 110 along with additional modular components. As depicted in FIG. 5A, environment 500 may include rails 440 that are connected to bed rails 111 of a pickup truck 110 using rail brackets 441 and are located directly behind roll bar 120. Environment 500 may also, or alternatively, include cargo rack 525 connected to cross bar 550 (not clearly shown in FIG. 5A) and to rails 440. Cargo rack bar 520 may be used to connect cargo rack 525 to rails 440. Cargo rack bar 520 may allow cargo rack 525 to be easily connected to rails 440. Cargo rack bar 520 may correspond to a member of sufficient strength to withstand the loads placed on cargo rack 525 and may be the correct length to ensure that cargo rack 525 is level when installed (i.e. when cargo rack is connected to cross bar 550 and to rails 440 using cargo rack bar 520. As shown in FIG. 5G, cross bar 550 extends between support bars 124 of roll bar 120 and provides for a connection between roll bar 120 and cargo rack 525.

FIG. 5B provides one example of how cargo rack bar 520 connects to rails 440. A mounting bracket 530 extends from rails 440 (rail 440-1 is shown, passenger side rail 440-2 may the same and/or similar) and provides a surface 531 on which cargo rack bar 520 may be installed, such as by using retainer 540 (i.e. retainer 540 may pass through apertures in mounting bracket 530 and cargo rack bar 520 to connect the two). Retainer 540 may correspond to a quick release fastener, such as a pin, a latch, a quarter turn fastener, a swell action latch, etc. Additionally, or alternatively, retainer 540 may correspond to conventional fastener, like a bolt and nut, etc. FIG. 5C provides an example of how cargo rack bar 520 may be connected to cargo rack 525. Cargo rack 525 may include a mounting bracket 525-9 that may be connected to cargo rack bar 520 using retainer 540. FIG. 5D provides an example of how cargo rack 525 may be connected to cross bar 550 of roll bar 120. In this example connection, cargo rack 525 is rotatably connected to cross bar 550 when retainer 540 passes through a bar bracket 525-8 extending from cargo rack 525 and through corresponding rack brackets 551. Rack brackets 551 are depicted as each having a pair of members through which retainer 540 is located to connect cross bar 550 to cargo rack 525. The structural arrangements of rack brackets 551 and bar brackets 525-8 are not limited to what is depicted in the drawings. As a result of this example configuration, a user may easily install cargo rack 525 to cross bar 550 using retainer 540 as shown in FIG. 5D to rotatably connect cargo rack 525 to cross bar, by rotating the cargo rack to the proper position (i.e. so that the cargo surface is approximately horizontal), and then using retainers 540 and a pair of cargo rack bars 520 to connect cargo rack 525 to rails 440.

FIGS. 5E and 5F depicts the example embodiment of cargo rack 525 of FIG. 5A. Cargo rack 525 may have the same or similar components as cargo rack 125. As shown in FIG. 5A, cargo rack 525 may be slightly larger than cargo rack 125, which is why the tailgate-end of cargo rack 525 is connected to rails 440 rather than support bar 124 (as is done with cargo rack 125). Cargo rack 525 may include, for instance, frame 525-3, cargo support members 525-4, cross members 525-6, a cargo surface 525-6, etc. Additionally, or alternatively, cargo rack 525 may include cross bar brackets 525-8 (two in this configuration) as well as mounting bracket 525-9. As shown in FIG. 5G, roll bar 120 may include cross bar 550 that is connected to (e.g. using fasteners, using a bracket with fasteners, etc.) support bars 124 (driver's side and passenger's side). Cross bar 550 may provide a pair of rack brackets 551, which are used to connect cross bar 550 to cargo rack as discussed in herein.

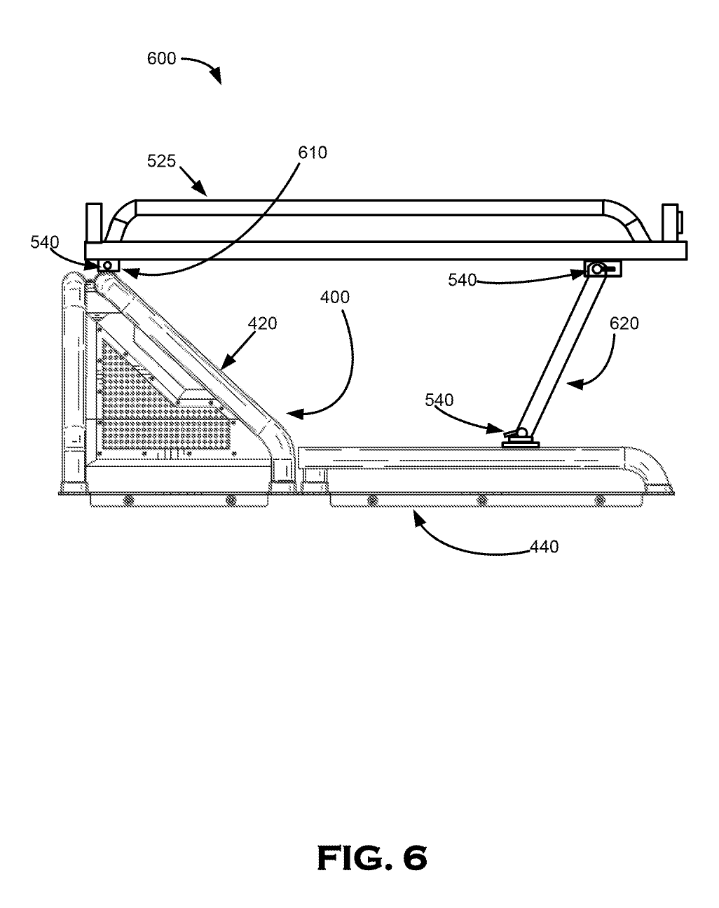

FIG. 6 illustrates an environment 600 including roll bar 400 along with additional modular components. As depicted in FIG. 5A, environment 600 may include rails 440 that are connected to cargo rack 525 via a cargo rack bar 610. Cargo rack bar 620 may be the same as, or similar to, cargo rack bar 520, but may correspond to a length appropriate for roll bar 400 (which may be same as, or different from, the length required for roll bar 120). Cargo rack bar 620 may connect to rails 440 and cargo rack 525 using fasteners in the same/similar ways described in FIGS. 5A-5G. Cargo rack 525 may be connected to second bar 420 of roll bar 400. In this configuration, second bar 420 may include rack brackets 610 which connect second bar 420 to cargo rack 525 in the same/similar way that rack brackets 551 connect cross bar 550 to cargo rack 525 using retainers 540. This may provide a rotatable connection between second bar 420 and cargo rack 525.

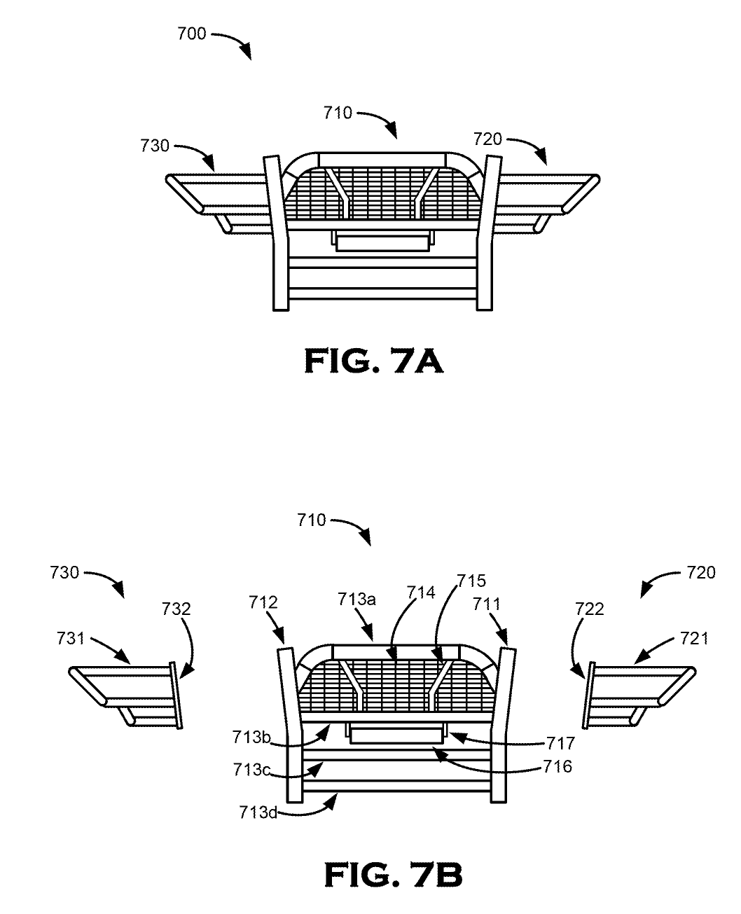

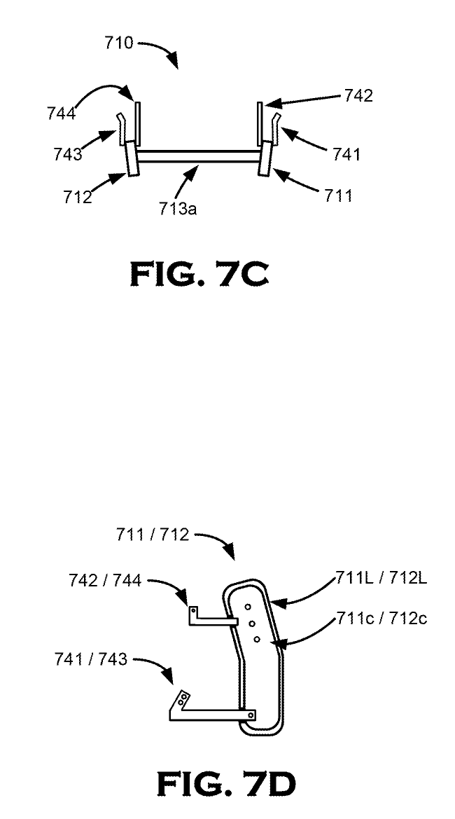

FIGS. 7A through 7D illustrate a non-limiting example embodiment of a modular grill guard that employees the technologies described herein. As shown in FIGS. 7A through 7D, Grill guard 700 may include a main guard 710, a right guard 720 and a left guard 730. The components illustrated in FIGS. 7A through 7D are provided for explanatory purposes only, and the disclosure herein is not intended to require the components reflected in FIGS. 7A through 7D. There may be additional components, fewer components, different components and/or differently arranged components than illustrated in FIGS. 7A through 7D. Also, in some implementations, one or more of the components/modules of the modular roll bar of FIGS. 7A through 7D may perform one or more of the functions of another one of the components illustrated in FIGS. 7A through 7D.

Main guard 710 may be section of modular roll bar 700 that may be mounted in the front center of a vehicle, usually just in front of the grill (i.e. in front of the radiator on most vehicles) of a vehicle. In general, main guard 710 is mounted in about the same area as a bull bar, which is another component that is mounted in the same general area as main guard 710. Main guard 710 may connect to the vehicle to secure the modular roll bar 700 to the vehicle, such as by using mounting brackets 740 as will be further explained with reference to FIGS. 7C and 7D. Main guard 710 may protect the front end of a vehicle, such as the grill, the radiator, the hood, the bumper, and other portions of the front end of the vehicle. This protection may be useful, for instance, when the vehicle is driven off road or in other areas where the front end may be struck by foreign objects. In the embodiment reflected in FIGS. 7A through 7D, main guard includes a right bar 711, a left bar 712, cross members 713, grill 714, grill members 715, light brackets 716 and light 717.

Right bar 711 and left bar 712 may include generally vertical segments (when installed on a vehicle) and are composed of one or more members each. As depicted in FIGS. 7A and 7B, right bar 711 and left bar 712 may be bent and/or include segments that are not vertical. In one embodiment, not depicted, right bar 711 and left bar 712 are formed from the same piece of material (e.g. tubing, etc.) and one or more of cross members may also be formed from this piece of material. Typically, right bar 711 and left bar 712 support the loads of modular roll bar 700 as a result of the fact that most embodiments of modular roll bar 700 are connected to a vehicle via right bar 711 and left bar 712, such as by using mounting brackets 740. Right guard 720 is removably connected to right bar 711, and left guard 730 is removably connected to left bar 712. Right bar 711 and left bar 712 may be formed from a wide variety of materials in a wide variety of ways, such as metal tubing, metal plate, machining, weldments, castings, etc. Typically, right bar 711 and left bar 712 include a generally flat surface or land (shown as 711c /712c in FIG. 7D) where they connect to right guard 720 and left guard 730 to provide a flat area where the brackets may contact. Further, right bar 711 and left bar 712 may include a lip 711L and 712L (shown in FIG. 7D) which may correspond to raised material around all or a part of the perimeter of right bar 711 and left bar 712 where they contact right guard 720 left guard 720 (i.e. to hide the connection brackets) and may include the same' to hide connections to cross members 713, grill 714, etc. As shown, the raised material may be removed in some areas, such as in the areas where connecting brackets 740 pass the lip.

Cross members 713 may correspond to structure of main guard 710 that connects right bar 711 and left bar 712. Cross members 713 may support and/or transfer the loads imparted on modular grill guard 700 between the right bar 711 and left bar 712. Cross members 713 may be permanently connected to left bar 711 and right bar 712, such as by welding, being formed as part of one or both of right bar 711 and/or left bar 712, etc. Additionally, or alternatively, cross members 713 may be removably connected to right bar 711 and/or left bar 712, such as by using fasteners, etc. In the embodiment depicted in FIGS. 7A through 7D, a first cross member 713a, second cross member 713b, third cross member 713c and fourth cross member 713d are shown. In other embodiments, there are more and/or less cross members than those illustrated in FIGS. 7A through 7D. Cross members 713 may protect the front end of a vehicle, and may be positioned to protect certain areas of the front end of the vehicle. For example, first cross member 713a may be positioned to protect a portion of the hood of a vehicle. Second cross member 713b may be positioned to protect the grill and/or radiator of a vehicle. Third cross member 714c and fourth cross member 714d may protect the bumper of a vehicle.

Grill 714 may correspond to a wireframe, etc. that may be connected (removably connected, permanently connected, etc.) to one or more of right bar 711, left bar 712, grill members 715 and/or cross members 713. While grill 714 is shown between first cross member 713a and second cross member 713b, grill 714 may be larger, smaller and/or reside in different areas of main guard 710. As depicted in FIGS. 7A and 7B, grill may be positioned in main guard 710 such that it protects the radiator and/or grill of the vehicle. Grill members 715 may be on either side of grill 714 (i.e. on the vehicle side or opposite the vehicle from the grill 714) and may add additional strength to main guard 710, may prevent grill 714 from flexing or contacting vehicle when grill is struck by an object (i.e. as a result of being connected to grill 714), etc. While grill members 715 are shown as being connected to cross members 713, grill members 715 may be connected to any other structure of main guard 710, including right bar 711, left bar 712, cross members 713, other grill members 715, etc. Light brackets may extend from cross grill members 715, such as when light 716 is mounted in front of grill 714.

As depicted in FIGS. 7A and 7B, light brackets 716 may extend from a cross member, such as second cross member 713b, and may connect light 717 to main guard 710. Light brackets 716 may support light 717. While light brackets 716 as being two brackets that connect to second cross member 713b, there may fewer light brackets or more light brackets 716. Also, in other configurations, light brackets 716 are connected to structure other than cross members 713, such as right bar 711, left bar 712, grill members 715, etc. Light 717 may correspond to a light that may provide light to the front of a vehicle, similar to a headlight. In some embodiments, light 717 may correspond to a high beam light, such as a halogen or high strength LED, that may act as spot light, etc., which may be useful for navigating off road.

Right guard 720 may be removably connected (e.g. using nuts and bolts, other fasteners, lock pins, etc.) to right bar 711 and may provide protection to the right front of a vehicle, generally from the right bar 711 to and around the right headlights of a vehicle. Similarly, left guard 730 may be removably connected to left bar 712 and may provide protection to the left front of a vehicle, generally from the left bar 712 to and around the left headlights of a vehicle. Right guard 720 and left guard 730 are typically symmetrical about the center of modular roll bar 700 so that the right and left side of the modular roll bar 700 look the same. However, right guard 720 and left guard 730 may have different appearances and/or different structural arrangements. In the embodiment depicted in FIGS. 7A through 7D, right guard 720 and left guard 730 are symmetrical and have the same structural arrangement.

Right guard 720 may include right guard members 721 which extend from right guard bracket 722, which is also part of right guard. Right guard members 721 may provide the protection of the right guard 720, such as by encircling the headlights and other structure on the right side of the front of the vehicle. Right guard members 721 are connected to (e.g. removably connected, such as by using fasteners, or permanently connected, such as by welding, etc.) to right guard bracket 722. Right guard bracket 722 may removably connect right guard 720 to right bar 711, such as by using fasteners, etc.

Left guard 730 may be the same as, or similar to, right guard 720 except, when installed, that left guard 730 may be located in front of the passenger's side of vehicle while right guard 720 is located in front of the driver's side of the vehicle. For example, left guard 730 may include left guard members 731 which extend from left guard bracket 732, which is also part of left guard. Left guard members 731 may provide protection of the left guard 730, such as by encircling the headlights and other structure on the left side of the front of the vehicle. Left guard members 721 are connected to left guard bracket 732. Left guard bracket 732 may removably connect left guard 730 to left bar 712, such as by using fasteners, etc.

Because right guard bracket 722 and left guard bracket are removably connected to right bar 711 and left bar 712, respectively, modular grill guard 700 may be installed by first installing main guard 710 to a vehicle and then installing right guard 720 and left guard 730. This may make it easier to install modular grill guard 700, because an installer does not have to install the main guard 710, right guard 720 and left guard 730 individually. Additionally, or alternatively, this arrangement may allow modular grill guard 700 to be packaged in a smaller package than traditional grill guards, making it easier and/or less expensive to ship modular grill guard 700 than traditional grill guards.

As illustrated in FIGS. 7C and 7D, main bar 710 may be connected to a vehicle using connecting brackets 740 (i.e. brackets 741, 742, 743 and 744 are referred to collectively as “connecting brackets 740)”. As shown, right bar 711 connects to a vehicle using a right lower connecting bracket 741 and a right upper connecting bracket 742. As shown in FIG. 7C and 7D, the upper connecting brackets 742/744 (right upper connecting bracket 742 and left upper connecting bracket 744 are collectively referred to as upper connecting brackets) may be the same, and the lower connecting brackets 741/743 (right lower connecting bracket 741 and left lower connecting bracket 743 are collectively referred to as lower connecting brackets) may be the same, such as when a vehicle has a structural arrangement that is the same on each side of the vehicle in the area where connecting brackets connect to the vehicle.

Lower connecting brackets 741/743 are ideally connected to the frame of a vehicle. Such connection may be direct or indirect. For example, lower connecting brackets 741/743 may extend from right bar 711 or left bar 713 under or through the bumper (i.e. directly through the bumper, such as through a penetration for tow hooks, etc. between the bumper and an air dam, etc.) when installed to connect to the right and left frame members of a vehicle. Additionally, or alternatively, lower connecting brackets 741/743 may connected indirectly to the frame of a vehicle, such as by connecting to other brackets that are connected to the frame, such as tow hook brackets, etc. When lower connecting brackets 741/743 are connected to the frame, they may support the modular grill guard 700. Upper connecting brackets 742/744 extend from right bar 711 and left bar 712 and typically connect to structural members of the vehicle at or near the radiator, behind the grill of a vehicle, etc. Upper connecting brackets 742/744 may further support modular grill guard 700. Connecting brackets 740 are depicted each as a single bracket. In many embodiments, connecting brackets 740 are formed from multiple brackets that are connected, such as by fasteners, etc., to connect modular grill guard 700 to a vehicle. This designs of connecting brackets 740 vary widely to accommodate different vehicles, which have different structural arrangements. Ideally, connecting brackets 740 connect to stronger structure of a vehicle, to provide the strongest support for modular grill guard 700; however, connecting brackets 740 may connect to any structure of a vehicle capable of supporting modular grill guard 700. Connecting brackets 740 may be designed so that they are inconspicuous (i.e. are located behind portions off modular grill guard 700, etc., and/or so that they pass through ideal locations on a vehicle, such as penetrations for tow hooks, openings in the grill of a vehicle, etc.

Connecting brackets 740 may be installed before other components of modular grill guard to facilitate the installation of modular grill guard 700. For example, connecting brackets 740 may be connected to a vehicle, and main guard 710 may be connected to the connecting brackets. Then, right guard 720 and left guard 730 may be connected to main guard 710. Alternatively, right guard 720 and left guard 730 may be connected to main guard 710 before connecting main guard 710 to connecting brackets 740.

The foregoing description provides illustration and description, but is not intended to be exhaustive or to limit the implementations to the precise form disclosed. Modifications and variations are possible in light of the above disclosure or may be acquired from practice of the embodiments. It will be apparent that the assemblies, systems, methods, technologies and/or techniques, as described above, may be implemented in many different forms of implementations described herein and illustrated in the figures. The actual or specialized hardware and/or materials used to implement the assemblies, systems, methods, technologies and/or techniques is not limited to the embodiments; it should be understood that hardware and/or materials may be designed to implement the apparatus, systems, methods, technologies and/or techniques based on the description herein. Unless otherwise, described herein, the items described herein e formed from one or more components (e.g. steel, aluminum, alloys, polymers, composite, fiberglass, etc.) of sufficient strength and rigidity to support the static and/or dynamic loads (e.g. forces, torques, tensions, compressions, stresses, strains, etc.) imparted on the items by users of the pickup truck (e.g. when holding on, etc.), by the ground or other objects when in the event of a roll over, by the other items (e.g. cargo, etc.) and/or from any other sources associated with these items. The components described herein may be corrosion resistant (e.g. coated and/or formed from corrosion resistant materials) such that they may be exposed to the environment (e.g. rain, humidity, salt water spray, etc.) without becoming corroded.

It should be emphasized that the terms “comprises”/“comprising” when used in this specification are taken to specify the presence of stated features, integers, steps or components but does not preclude the presence or addition of one or more other features, integers, steps, components, or other groups thereof.

No element, act or instruction used in the present application should be construed as critical or essential to the embodiments unless explicitly described as such. Also, as used herein, the articles “a” and “an” are intended to include one or more items and may be used interchangeably with “one or more.” Where only one item is intended, the term “one” or similar language is used. Further, the phrase “based on” is intended to mean “based, at least in part, on” unless explicitly stated otherwise.

While preferred embodiments of the invention have been shown and described, those skilled in the art will recognize that other changes and modifications may be made to the foregoing embodiments without departing from the scope and spirit of the invention. For example, specific shapes of various elements of the illustrated embodiments may be altered to suit particular applications. Additionally, the modular roll bar may have different components or be designed in different shapes using different methods of connection without departing from the spirt of the invention disclosed herein. For example, while many of the components of the modular roll bar are depicted as having a tubular design, the components may be formed from non-tubular construction. Additionally, or alternatively, various components may be added to and/or subtracted from modular roll bar without departing from the spirit of the invention. Further, the embodiments disclosed herein may be used in different applications. For example, the embodiments disclosed herein may be used on vehicles other than pickup trucks (e.g. jeeps, sport utility vehicles, etc.). It is intended to claim all such changes and modifications as fall within the scope of the disclosure herein and the, equivalents.

What is claimed is:

1. A modular grill guard that is designed to be mounted in front of a vehicle, the modular grill guard comprising:
a main guard that is installed in the front and center of a vehicle, the main guard including a right bar, a left bar and a first cross member connected to the right bar and the left bar;
a right guard that is removably connected to the right bar, the right guard including
a right guard member that protects the right headlight when installed on a vehicle, and
a right guard bracket, the right guard bracket providing the removable connection to the right bar, the right guard member extending from the right guard bracket;
a left guard that is removably connected to the left bar, the left guard including
a left guard member that protects the left headlight when installed on a vehicle, and
a left guard bracket, the left guard bracket providing the removable connection to the left bar, the left guard member extending from the left guard bracket;
a first connecting bracket that extends from the right bar to connect the modular grill guard to the vehicle; and
a second connecting bracket that extends from the left bar to connect the modular grill guard to the vehicle.

2. The modular grill guard of claim 1, where the main guard further includes a grill.

3. The modular grill guard of claim 2, where the main guard further includes a second cross member connected to the right bar and the left bar, the grill extending between the first cross member and the second cross member.

4. The modular grill guard of claim 1, further including light brackets and a light connected to the main guard by the light brackets.

5. The modular grill guard of claim 4, where the light brackets are connected to a second cross member that is connected to the right bar and the left bar.

6. The modular grill guard of claim 2, further including grill members connected to the grill.

7. The modular grill guard of claim 1, where the right bar includes a first land and the left bar includes a second land, the right guard bracket connected to the right bar at the first land and the left guard bracket connected to the left bar at the second land.

8. The modular grill guard of claim 7 further including a first lip extending around the first land and a second lip extending around the second land.

9. The modular grill guard of claim 1, where the first connecting bracket and the second connecting bracket are connectable to the frame of the vehicle.

10. The modular grill guard of claim 1, further including a third connecting bracket extending from the right bar and a fourth connecting bracket extending from the left bar.

11. The modular grill guard of claim 1, where the right bar and the left bar are formed from separate pieces of material.

12. The modular grill guard of claim 1, where each of the right bar and the left bar are formed from a single piece of material.

13. The modular grill guard of claim 3, further including a third cross member and a fourth cross member, each of the third cross member and the fourth cross member being connected to the right bar and the left bar.
